(19) United States
(12) Patent Application Publication
(10) Pub. No.: US 2009/0285428 A1
(43) Pub. Date: Nov. 19, 2009

(54) Ergonomic insertion tool for an open ear hearing aid

(76) Inventor: Karl H. Gilgert, Poughkeepsie, NY (US)

Correspondence Address: SAILE ACKERMAN LLC, 28 DAVIS AVENUE, POUGHKEEPSIE, NY, 12603, US

(21) Appl. No.: 12/152,994

(22) Filed: May 19, 2008

(51) Int. Cl. H04R 25/02

(52) U.S. Cl. 381/329

(57) ABSTRACT

An ergonomically designed tool for detachably mounting an earpiece dome having a receiver and an acoustic air tube/wire to a variety of open ear hearing aids includes using a cylindrically shaped body having a length configured to be held with the fingers of a relaxed free floating hand for inserting and properly seating the dome into an ear canal.

### BACKGROUND OF THE INVENTION

(1) Technical Field

The present invention relates generally to a hearing aid and more specifically to an earpiece insertion device for self use while inserting the earpiece.

(2) Description of the Prior Art

Hearing aids of the type used to assist a person having impaired hearing to perceive sound properly have improved greatly since their inception, so much so, that they are no longer cumbersome to carry and today are readily accepted as a hi-tech device that is easy and almost unnoticeable to wear. Both moderate and advanced technologies mean that hearing aids can now be programmed with a computer for various listening situations. Both advanced technologies may offer multiple channels and multiple microphones. Both advanced technologies allow the audiologist to shape the hearing aid's responses to various listening situations and gives the user more control over the hearing instrument. One type, specifically an open ear type of hearing aid that uses a receiver for directing and amplifying the sound via an air tube/wire to an ear-piece that is inserted into the auditory canal is the type of hearing aid to which this invention particularly relates to.

FIGS. 1a, 1b and 1c are perspective views of a conventional open ear hearing apparatus of the prior art, illustrating several viewpoint positions of an earpiece dome 102 with receiver unit 103 attached at the proximal end of a air tube/wire 104. The earpiece dome diameters are available in 6 mm, 8 mm and 10 mm sizes. FIG. 1a illustrates a conforming behind the ear microphone module 101 proximally connected to a top of ear formed air tube/wire section 107 wherein the distal end section of the air tube/wire 104 connects to receiver unit 103 and earpiece dome 102. FIG. 1b illustrates a partial side and frontal view of the earpiece dome 102 with receiver unit 103 connected to the end section of the air tube/wire 104. FIG. 1c illustrates the back-side of microphone module 101 showing a clip-on microphone cover 106 securing batteries in battery compartment 105 also again showing the top of ear formed air tube/wire section 107 with the distal end section of the air tube/wire 104 connected to receiver unit 103 and earpiece dome 102. The insertion length of the air tube/wire 104 connected to the power pack and dome/receiver unit permits the correct depth insertion of the dome/receiver unit in to the ear canal. The insertion length is fashioned by an Audiolagist while fitting and forming the tip of ear air tube/wire section 107.

A principle disadvantage of existing hearing aids, of the type just referred to is that the receiver unit must be properly inserted and seated in the auditory canal. Due to its small size, proper seating of the dome-receiver unit is very difficult to manipulate using only the feel of fingertips. Moreover, the delicate wire or air tube connected to the receiver unit may be damaged during insertion.

### SUMMARY OF THE INVENTION

Hearing aid technology has come far, however, even the most advanced hearing aids cannot bring the speaker's voice closer to the listener's ear. In order to accomplish that, open ear hearing instruments with assistive listening devices must be used in addition to hearing aids, since the loudness of the speaker's voice decreases with distance. This is true for the hearing aid user, and the non-hearing user alike.

Accordingly, counseling an individual about the advantages of a hearing instrument that includes a strong telecoil that picks up signals from various magnetic sources should be a factor of any hearing aid evaluation and fitting process. Moreover, to ensure the finest hearing with a hearing instrument, proper seating of the dome receiver unit is essential. The present invention assists in properly seating the dome receiver unit into the auditory canal. The fashioned length of the wire or tube connected to the power pack and dome/receiver unit permits the correct depth insertion of the dome/receiver unit into the ear canal

It is an object of the present invention to improve the methodology for inserting a dome receiver portion of a hearing aid into the auditory canal.

It is still another object of the present invention to prevent damage to the insubstantial air tube or wire thereon connecting the dome receiver portion of the hearing aid. to the clip-on microphone

It is yet another object of the present invention to eliminate the use of a person's fingertips for insertion of the dome receiver portion thereby improving the human factor by allowing the user more degrees of freedom for properly inserting the dome receiver into the auditory canal.

The foregoing, together with other objects features and advantages of this invention, can be better appreciated with reference to the following specification, claims, and the accompanying drawings.

### BRIEF DESCRIPTION OF THE DRAWINGS

FIGS. 1a, 1b and 1c are perspective viewpoints of a conventional open ear hearing aid of the prior art.

FIG. 2a, illustrates a perspective view of the insertion tool of the invention.

FIG. 2b illustrates a planar top view of the insertion tool of the invention.

FIG. 3 is a rendering showing the actual application of the insertion tool of the invention.

### DETAILED DESCRIPTION OF THE PREFERRED EMBODIMENT

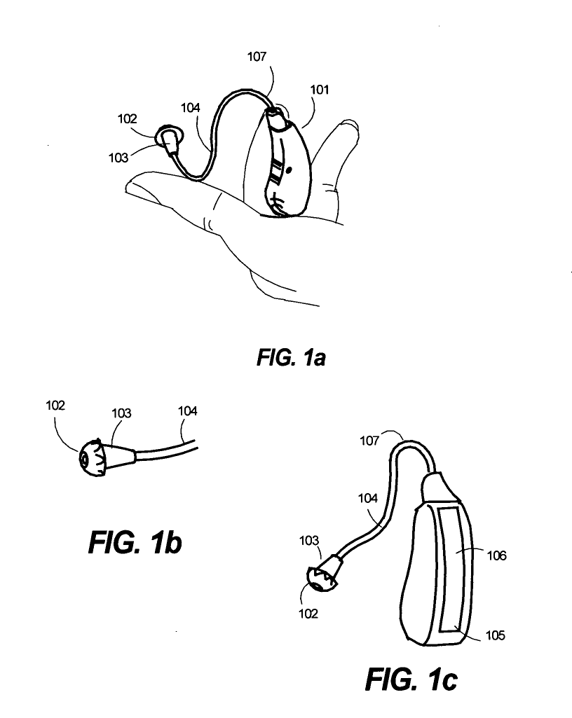

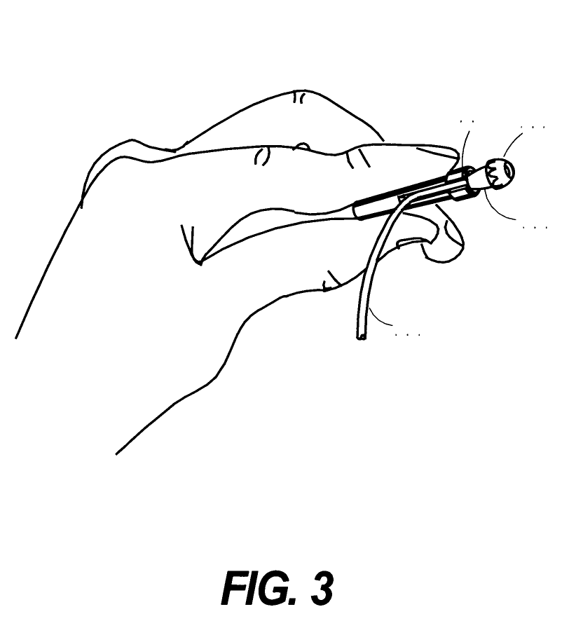

As described earlier, FIGS. 1a-1c illustrate a conventional open ear hearing aid showing various viewpoints of a dome and receiver unit to which this invention relates. The earpiece dome diameters at present are in 6, 8 and 10 mm sizes. FIG. 1a shows a behind the ear microphone module proximally connected to a top of ear formed air tube/wire section wherein the distal end section of air tube/wire connects with receiver unit and earpiece dome. FIG. 1b illustrates a partial side and frontal view of the earpiece dome with receiver unit connected to the air tube. FIG. 3 shows the backside of microphone module showing a clip-on microphone cover securing batteries in battery compartment.

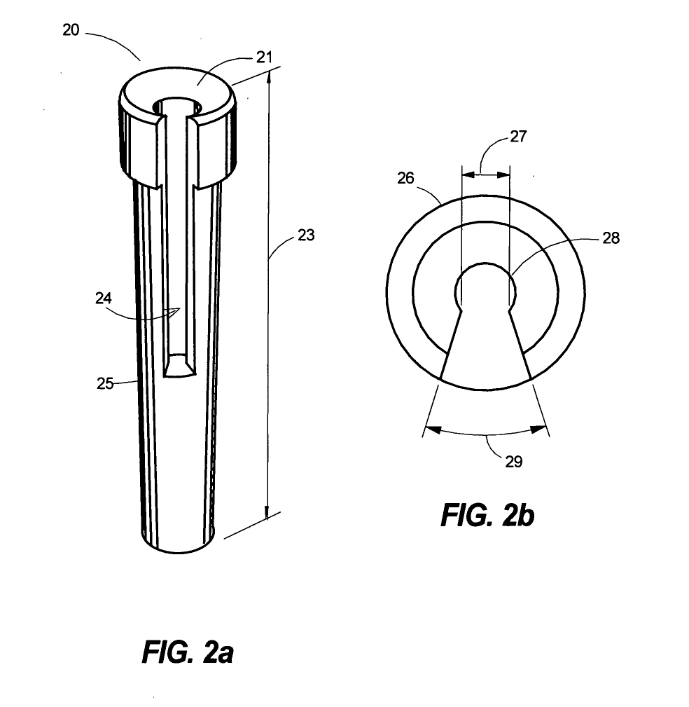

Referring to the drawings and especially FIG. 2a thereof, an earpiece insertion tool 20 is a human engineered component that is designed to be complementary for inserting the ear-piece dome 102, shown in FIGS. 1a-1c, to a proper depth into the auditory canal. The earpiece insertion tool operates as an extension for the fingers and can accommodate a plurality of dome sizes and shapes. It is made using an ABS plastic. Referring also to FIGS. 2a, 2b and 3, illustrating how the insertion tool 20 is used. The tool 20 has a receiving slot 24, having a proper length, to receive by interposing the air tube/wire 104 within the receiving slot 24. A lead-in channel 29 having an angle of about 34° helps guide the tube into the opened bore 28 (best illustrated in the top view of FIG. 2b). The bottom of the dome receiver 103 is placed and uprightedly supported by conical surface 21 of tool 20. The proper length of the air tube/wire 104, specified by a fitting Audioligist, permits the correct insertion depth of the dome/receiver unit into the ear canal.

To accommodate the presently available 6, 8 and 10 mm earpiece domes, two earpiece tool sizes are offered having similar embodiments. A first tool is provided for the 6 mm dome having dimensions that are labeled “21, 26, 27 and 28 that are adjusted to correspond with the smaller, 6 mm dome. A second insertion tool is provided for both the 8 and 10 mm domes. The labeled dimensions “21, 26, 27, and 28 are similarly adjusted to correspond with the larger, 8 and 10 mm domes. However, the design is not limited to the present dome sizes and is easily adaptable for a plurality of sizes and shapes. The tools are made using a plastic comprising acrylonitrile butodiene (ABS) acrylonitrile styrene (AS) or styrene acrylonitrile (SAN).

In summary, a hand held insertion tool for holding an open ear hearing aid dome is disclosed. The hearing aid dome has an attached receiving unit and flexible tube. The insertion tool includes a cylindrically shaped body having a length configured to be held with the fingers of a relaxed free floating hand. The body comprises a top flanged portion with a concave conical surface and a centered bore extending downward. A lead-in channel is formed starting at the top flanged periphery extending downward below the flanged surface while inwardly converging and conjoining with the bore. The bore and lead-in channel has a depth to accommodate a length portion of the flexible tube without crimping the flexible tube. The receiving tube is inwardly guided by the lead-in channel and urged into the open bore segment, thereafter the receiving tube is pulled downward until the bottom of the dome in cradled and supported by the concave top surface.

While the invention has been particularly shown and described with reference to the preferred embodiments thereof, it will be understood by those skilled in the art that various changes in form and details may be made without departing from the spirit and scope of the invention.

What is claimed is:

1. A hand held insertion tool for holding an open ear hearing aid dome having an attached receiving unit and flexible tube/wire, said insertion tool comprising: a cylindrically shaped body having a length configured to be held with the fingers of a relaxed free floating hand for properly inserting and seating said dome into an ear canal, said body having an upper flange with a concave conical top surface and a centered bore extending downward, a lead-in channel starting at said upper flange periphery continuing longitudinally below said flange bottom surface, inwardly converging and conjoining with said bore.

2. The hand held insertion tool of claim 1 wherein said bore and lead-in channel having a depth to accommodate a length portion of said flexible receiving tube/wire without crimping said tube/wire.

3. The hand held insertion tool of claim 1 wherein said receiving tube/wire is urged into said bore segment while being guided by said lead-in channel.

4. The hand held insertion tool of claim 3 wherein said receiving tube/wire is pulled downward so that the dome is axially cradled and supported by the concave top surface of the cylindrically shaped body.

5. The hand held insertion tool of claim 1 wherein said tool is made from a plastic material comprising acrylonitrile butodiene (ABS) acrylonitrile styrene (AS) or styrene acrylonitrile (SAN).

6. The hand held insertion tool of claim 1 wherein said open ear hearing aid dome is presently available in 6, 8 and 10 mm sizes wherein two insertion tools are provided, a first tool having dimensions that are designed to conform to the 6 mm size and a second tool having dimensions designed to conform to both the 8 and 10 mm sizes.

7. The hand held insertion tool of claim 6 wherein said first tool dimensions having a flange diameter of about 7 mm, a conical diameter of about 6 mm with a cone angle of about 60°, a bore diameter of about 2.7 mm×of about 25 mm deep, and a taper to bore break-through dimension of about 2.2 mm.

8. The hand held insertion tool of claim 6 wherein said second tool dimensions having a flange diameter of about 8.2 mm, a conical diameter of about 7 mm with a cone angle of about 60°, a bore diameter of about 3 mm×of about 25 mm deep, and a taper to bore break-through dimension of about 2.5 mm

9. The hand held insertion tool of claim 7 wherein said lead-in taper to bore break-through dimension is designed to be narrower than said tube/wire diameter so that the tube/wire supply conforms and passes through and into said open bore.

10. The hand held insertion tool of claim 1 wherein all the other dimensions are the same for both sizes, i.e., length of tool is about 45 mm, flange length is about 6 mm, the lead-in angle is about 34°, and all edges having radii of about 0.5 mm.

11. The hand held insertion tool of claim 1 wherein the use of said insertion tool provides more degrees of freedom for properly inserting and seating said domes of present and future sizes into said ear canal.

12. The hand held insertion tool of claim 1 wherein the use of said inserting tool prevents damage and breakage to said tube/wire while inserting said hearing aid dome into said ear canal.

13. A method for inserting an open ear hearing aid dome into an ear canal, comprising the steps of:
providing a hand held insertion means, said insertion means comprising a cylindrically shaped body having a length configured to be held with the fingers of a relaxed free floating hand for properly inserting and seating said dome into an ear canal, said body having an upper flange with a concave conical top surface and a centered bore extending downward, a lead-in channel starting at said upper flange periphery continuing longitudinally below said flange bottom surface, inwardly converging and conjoining with said bore.

14. The method of claim 13 wherein said bore and tapered slot having a depth to accommodate a length portion of said flexible receiving tube/wire without crimping said tube/wire.

15. The method of claim 13 wherein said receiving tube/wire is urged into said bore segment while being guided by said lead-in channel.

16. The method of claim 13 wherein said receiving tube/wire is pulled downward so that the dome is axially cradled and supported by the concave top surface of the cylindrically shaped body.

17. The method of claim 13 wherein said open ear hearing aid dome is available in 6 mm, 8 mm and 10 mm sizes wherein two insertion tools are provided, a first tool having dimensions that are designed to conform to the 6 mm size and a second tool having dimensions designed to conform to both the 8 and 10 mm sizes.

18. The method of claim 13 wherein the use of said dome insertion tool provides more degrees of freedom for properly inserting and seating said domes of all sizes to maximize audio discernment.

19. The method of claim 13 wherein the use of said inserting tool prevents damage and breakage to the tube while inserting said hearing aid dome into said ear canal.
